(19) United States
(12) Patent Application Publication
(10) Pub. No.: US 2024/0145205 A1
(43) Pub. Date: May 2, 2024

(54) TARGET STRUCTURE FOR GENERATION OF X-RAY RADIATION

(71) Applicant: Siemens Healthcare GmbH, Erlangen (DE)

(72) Inventors: Sven MUELLER, Urbich (DE); Lars FUHRMANN, Freiberg (DE); Tobias HEINKE, Rudolstadt (DE); Marvin MOELLER, Jena (DE); Joerg FREUDENBERGER, Kalchreuth (DE); Stefan WILLING, Rudolstadt (DE); Peter ROEHRER, Erlangen (DE)

(73) Assignee: Siemens Healthcare GmbH, Erlangen (DE)

(21) Appl. No.: 17/975,713

(22) Filed: Oct. 28, 2022

(51) Int. Cl. H01J 35/12; H01J 35/10; H05H 7/14; H05H 9/00

(52) U.S. Cl. CPC H01J 35/12; H01J 35/105; H05H 7/14; H05H 9/00; H01J 2235/081; H01J 2235/1291

(57) ABSTRACT

A target structure for generation of x-ray radiation may include a heat sink; and a target element for electrons to strike, the target element being in the heat sink to cool the target element, wherein the heat sink includes a metal-diamond composite material.

### FIELD

One or more example embodiments of the present invention relates to a target structure for generation of x-ray radiation, to a linear electron accelerator, to a stationary anode transmission x-ray tube, to a stationary anode reflection x-ray tube and to a rotating anode reflection x-ray tube.

### STATE OF THE ART

A conventional target structure for generation of x-ray radiation comprises at least one target element for electrons to strike. During the interactions of the electrons with the target element for generation of x-ray radiation typically only a small part of the kinetic energy can be used, while a relatively large part is merely converted into heat.

Due to the comparatively high electron energy values in the range of between 20 and 150 keV for diagnostic imaging applications or between 1 and 18 MeV for radiotherapy or non-destructive materials or safety testing applications, the tube neck is the guarantee of a sufficient heat dissipation from the target. Otherwise, with such high radiation powers or pulse energies, the target element can age prematurely, be damaged or even be destroyed. Therefore conventional target elements are embedded in a heat sink for example, which makes it possible to dissipate the heat of the target element and which, by comparison with the target element its can generate comparatively little x-ray or scattered radiation. A conventional heat sink of this type usually consists of copper.

In the unexamined patent application DE 29 26 823 A1, a linear electron accelerator with an apparatus for generation of bremsstrahlung radiation (braking radiation) is described. The apparatus for generation of bremsstrahlung radiation has a target element that consists a material with a comparatively high atomic number, for example tungsten (W, Z=74). The target element is mounted in a carrier that consists of a material with a high thermal conductivity λ, for example copper (Cu, Z=29) with a thermal conductivity of λCu=400 W/(m·K). In order to guarantee a thermal link between the target element and the carrier that is as good as possible, the target element is connected on its outer surfaces and/or its base surface by material-fit connection to the surface of the carrier. Furthermore a cooling channel is arranged in the carrier, which runs around the target element and in which a liquid cooling medium circulates (indirect cooling of the target). Since only one cooling channel is present, only relatively small cooling surfaces are produced and thus there is only a correspondingly small dissipation of heat.

A further option is a reduction of the energy per x-ray pulse or a lengthening of the cooling-down time between two consecutive x-ray pulses. The power reduction typically requires an increase in the pulse repetition rate. In this case efficiency in the generation of x-ray radiation is usually reduced.

As an alternative or in addition the expansion of the focal spot in the target structure, in particular in the target element, in which the interaction with the electrons for generation of the x-ray radiation occurs, can lead to the energy deposited by the electrons in the focal spot not leading to an ageing of the target element. The greater the expansion of the focal spot the less sharp the imaging or irradiation generated by this x-ray radiation becomes. Therefore a focal spot that is as small as possible is ideal.

DE 10 701 210 681 A1 relates to an apparatus for generation of bremsstrahlung radiation with a bremsstrahlung radiation target that is arranged in a carrier and is able to be cooled by a cooling facility. The bremsstrahlung radiation target is embedded in the carrier and the carrier is surrounded by a ring on its circumferential surface, wherein the ring has a smaller thermal expansion than the carrier. Such an apparatus is able to withstand high thermal stress and has a long lifetime.

A further known target element is embodied in a rotatable manner so that it turns during the generation of x-rays and can be directly cooled for example in a liquid cooling medium. Depending on embodiment this enables the electron beam directed onto the target element to be widened, wherein the lack of sharpness is increased. What is more the direct cooling can cause a chemical wear through oxidation of the cooling medium and of the target element.

A liquid metal target element is furthermore known from the prior art. As a requirement of the type of construction the cooling is improved at the cost of an increased lack of sharpness, since a liquid metal target element usually has a lower density than a conventional tungsten (rhenium) target.

### SUMMARY

One or more example embodiments provides a target structure for generation of x-ray radiation, a linear electron accelerator, a stationary anode transmission x-ray tube, a stationary anode reflection x-ray tube and a rotating anode reflection x-ray tube in which the thermomechanical stability of the target element is improved.

According to one or more example embodiments, a target structure for generation of x-ray radiation includes a heat sink; and a target element for electrons to strike, the target element being in the heat sink to cool the target element, wherein the heat sink includes a metal-diamond composite material.

According to one or more example embodiments, the target element includes silver, copper, gold, aluminum, rhodium, tungsten, molybdenum, rhenium, zirconium, chrome, cobalt, iron, manganese, vanadium, titanium, tantalum, indium, iridium or beryllium or an alloy thereof, and the target element is a different structure from the heat sink.

According to one or more example embodiments, a metal of the metal-diamond composite material is silver, copper, gold, aluminum, rhodium, tungsten, molybdenum, rhenium, zirconium, chrome, cobalt, iron, manganese, vanadium, titanium, iridium or beryllium.

According to one or more example embodiments, the metal-diamond composite material includes a metal between diamond grains.

According to one or more example embodiments, a thermal conductivity of the metal-diamond composite material at room temperature is at least 400 W/(m·K).

According to one or more example embodiments, the thermal conductivity of the metal-diamond composite material is at least twice a thermal conductivity of the target element.

According to one or more example embodiments, coefficient of thermal expansion of the metal-diamond composite material is less than 12 ppm/K.

According to one or more example embodiments, coefficient of thermal expansion of the metal-diamond composite material is at most three times a coefficient of thermal expansion of the target element.

According to one or more example embodiments, the target element is held in the heat sink by a material-fit connection.

According to one or more example embodiments, the heat sink completely surrounds the target element.

According to one or more example embodiments, a linear electron accelerator includes linearly arranged cavities configured to accelerate electrons as part of an evacuated housing; an electron emitter configured to emit the electrons in the evacuated housing; and the target structure in the evacuated housing, wherein the target element is between an x-ray emission window of the evacuated housing and the electron emitter.

According to one or more example embodiments, the target structure is soldered vacuum-tight to the evacuated housing and forms the x-ray emission window.

According to one or more example embodiments, a stationary anode transmission x-ray tube comprises an evacuated housing; an electron emitter configured to emit electrons in the evacuated housing; and the target structure being a stationary anode in the evacuated housing, wherein the target element is between an x-ray emission window of the housing and the electron emitter.

According to one or more example embodiments, a stationary anode reflection x-ray tube comprises an evacuated housing; an electron emitter configured to emit electrons in the evacuated housing; and the target structure being a stationary anode in the evacuated housing, wherein an x-ray emission window of the evacuated housing is to the side of or opposite the target structure.

According to one or more example embodiments, a rotating anode reflection x-ray tube comprises an evacuated housing; an electron emitter configured to emit electrons in the housing; and the target structure being a rotating anode in the evacuated housing, wherein an x-ray emission window of the evacuated housing is to the side of or opposite the target structure.

### BRIEF DESCRIPTION OF THE DRAWINGS

Example embodiments are explained and illustrated in greater detail below with the aid of the exemplary embodiments shown in the figures. In principle, in the description of the figures given below, structures and units that in principle stay the same are labeled with the same reference characters that they are given the first time that the respective structure or unit occurs.

In the figures:

FIG. 1 shows a target structure according to an example embodiment,

FIG. 2 shows the target structure in an alternate form of embodiment,

FIG. 3 shows the target structure in a further form of embodiment,

FIG. 4 shows a conventional target structure,

FIG. 5 shows the thermodynamic behavior of the conventional target structure,

FIG. 6 shows the thermodynamic behavior of the inventive target structure according to an example embodiment,

FIG. 7 shows the thermodynamic behavior of the target structure with completely enclosed target according to an example embodiment,

FIG. 8 shows a stationary anode reflection x-ray tube according to an example embodiment,

FIG. 9 shows a linear electron accelerator according to an example embodiment,

FIG. 10 shows a target structure in a further embodiment and

FIG. 11 illustrates a target structure and electron emitter according to an example embodiment.

### DETAILED DESCRIPTION

An inventive target structure for generation of x-ray radiation has
a heat sink and
a target element for electrons to strike, which is embedded in the heat sink for cooling of the target element,
   characterized in that
   the heat sink essentially consists of a metal-diamond composite material.

One advantage of the target structure is that a metal-diamond composite material can be processed more easily in terms of construction when compared with a copper heat sink used conventionally. The metal-diamond composite material advantageously makes it possible to optimize the cooling geometry, including enlarging the surface with cooling ribs, of the heat sink due to the constructional freedom.

A further advantage can be that the lower density of the metal-diamond composite material by comparison with copper increases the photon yield during the generation of x-ray radiation in the target element.

As an alternative or in addition the metal-diamond composite material is advantageous because ideally a coefficient of thermal expansion of the metal-diamond composite material and a coefficient of thermal expansion of the target material can be approximated to one another. The approximation of the coefficients of thermal expansion in particular optimizes the thermomechanical binding of the target element and the heat sink. The thermomechanical binding is preferably low-stress, in particular during operation of the target structure. Equally the metal-diamond composite material typically provides a high thermal conductivity in order, during electron bombardment of the target structure, to be able to cool the said structure sufficiently. Advantageously the metal-diamond composite material makes possible an increase in power during the operation of the target structure and/or an increase in service life of the target structure. Typically the metal-diamond composite material has a comparatively high specific heat capacity.

The target structure for generation of x-ray radiation is in particular an apparatus for generation of bremsstrahlung radiation with a bremsstrahlung radiation target. Depending on application the x-ray radiation can for example have energy values in the range of between 20 and 150 keV in diagnostic imaging or non-destructive materials testing applications and/or between 1 and 18 MeV in radiotherapy or non-destructive materials and safety testing applications. For energy values in the MeV range the x-ray radiation is typically called MeV x-ray radiation.

The target element is that area of the target structure, which during operation makes a significant contribution to the generation of the x-ray radiation. The target element preferably includes the focal spot completely. The x-ray radiation is in particular generated by electrons striking the target element in the target structure. The target element can form a first area of the target structure and the heat sink can form a second area of the target structure. In an ideal target structure only the target element contributes to the generation of the x-ray radiation, while no electrons are scattered in the heat sink. The efficiency in the generation of the x-ray radiation and thus the share of useful x-ray radiation is determined in particular by the material of the target element and/or the thickness of the target element. The target element is in particular a bremsstrahlung radiation target. The target element is in particular suitable for electrons with an energy of greater than 20 keV, in particular greater than 1 MeV to strike.

The target element is typically arranged in the heat sink. The target element is preferably embedded in a form fit in the heat sink. The heat sink in particular carries the target element. The target element is typically exclusively fastened to the heat sink. The embedding of the target element in the heat sink means that the full surface of the target element is in contact with the heat sink for a dissipation of heat. Typically at least the sides of the target element that are facing away from the electron emitter and are thus not in direct contact with the electron beam are at least partly in contact with the heat sink. In other words at least one side of the target element, at least in sections, is typically in contact with a vacuum.

The target element is typically in the shape of a round body, in particular when the target element is able to be differentiated structurally from the heat sink. The round body is a cylindrical body, usually with a low height compared to its diameter. The target element consists of a material with a high ordinal number (atomic number, and/or high density, for example silver, copper, gold, aluminum, rhodium, tungsten, molybdenum, rhenium, zirconium, chrome, cobalt, iron, manganese, vanadium, titanium, tantalum, indium, iridium or beryllium or an alloy of the conventional target materials described above. The target material of the target element can in particular be tungsten. Advantageously the target element, in addition to tungsten, features rhenium for example, so that the target element is tougher and thus more robust. Such a tungsten-rhenium target element typically fractures later than a pure tungsten target at a comparable load.

The average electron free path length depends on the energy of the incoming electrons. The target element is typically dimensioned in such a way that an expansion in each spatial direction amounts to at least a half, preferably a whole mean electron free path length. This advantageously enables the proportion of electrons that interact in the target element to be increased. when the target element is embodied as a round body then the low height usually amounts to at least 50% or 100% of the mean electron free path length, while a radius of the round body is typically significantly larger, for example from 2 mm and/or up to 10 mm or 25 mm.

In principle, the target structure is suitable for a reflection and/or a transmission with regard to the generated x-ray radiation. Typically an efficiency of a reflection target structure is higher for electron energies below 1 MeV, while an efficiency of a transmission target structure is higher for electron energies above 1 MeV. The efficiency is related to the useful radiation. Useful radiation is that x-ray radiation which is emitted from the housing according to specification and can be used for the application. With a reflection target structure a large part of the x-ray radiation generated as a function of the incoming electrons is reflected back from the target structure and/or is reflected laterally. With a transmission target structure a large part of the x-ray radiation generated as a function of the incoming electrons preferably penetrates the target structure.

The heat sink is a heat-dissipating element of the target structure. The heat sink preferably exclusively features the metal-diamond composite material. In principle, it is advantageous for the heat sink to consist exclusively of the metal-diamond composite material. Preferably the heat sink thus consists of the metal-diamond composite material. The heat sink advantageously only has an insignificant proportion of further materials, which preferably can barely reduce and/or cannot reduce the thermal properties of the metal-diamond composite material. The further materials can in particular be provided for stabilization of the heat sink and/or for enhancing the cooling performance, for example via a heat pipe, Depending on the geometry of the heat sink and/or depending on the power range of the target structure, a further heat sink can be provided for cooling of the target element and/or of the heat sink in the target structure.

The heat sink and/or the target element, on a side facing away from the electron beam, can be in contact with a cooling medium. This preferably enables the heat sink to be cooled during operation. Advantageously the cooling medium is essentially transparent for the generated x-ray radiation.

The metal-diamond composite material in particular forms a metal-diamond matrix. The metal-diamond composite material is characterized by its components of metal and diamond. The metal-diamond composite material is a mixture of unmixed metal and diamond. The diamond consists in particular of diamond powder. The diamond powder in particular has a plurality of diamond grains. The diamond is a carbon-based diamond. In principle, other minerals and/or crystalline substances are conceivable as a substitute for diamond with corresponding thermal properties in conjunction with the metal.

One form of embodiment makes provision for the target element to consist of silver, copper, gold, aluminum, rhodium, tungsten, molybdenum, rhenium, zirconium, chrome, cobalt, iron, manganese, vanadium, titanium, tantalum, indium, iridium or beryllium or an alloy of the target materials described above and in particular the target element is able to be differentiated structurally from the heat sink. In this form of embodiment a conventional target able to be differentiated structurally is combined with the heat sink made of the metal-diamond composite material.

One form of embodiment makes provision for the metal-diamond composite material to have as its metal silver, copper, gold, aluminum, rhodium, tungsten, molybdenum, rhenium, zirconium, chrome, cobalt, iron, manganese, vanadium, titanium, iridium or beryllium. The aforementioned metals can be provided in unmixed or in mixed form, for example an alloy, in particular tungsten-rhenium or titanium-zirconium-molybdenum, as metal in the composite material. In principle, all conventional target materials come into consideration as metal in the metal-diamond composite material.

One preferred form of embodiment provides for the metal-diamond composite material to be a gold-diamond composite material or a silver-copper-aluminum-diamond composite material. This form of embodiment is in particular advantageous if the target element and the heat sink consist of the same metal-diamond composite material.

A further preferred form of embodiment makes provision for the metal-diamond composite material to be a silver-diamond composite material. The choice of silver as metal (in unmixed form) is especially advantageous because with such a composite material for example in a temperature range of between 0 and 200° C. a thermal conductivity of between 700 and 1000 W/(m·K), for example at 20° room temperature above 800 W/(m·K), can be present. The silver-diamond composite material typically has a coefficient of thermal expansion in the range of around 6 ppm/K and/or a specific heat capacity in the range of around 310 J/(kg·K). This form of embodiment is in particular advantageous in combination with a conventional target element, structurally different from the heat sink.

One form of embodiment makes provision for the metal-diamond composite material to consist of diamond grains, between which metal is located. The diamond grains originate in particular from diamond powder. Depending on the dimensioning of the diamond grains a space, in which the metal is provided, exists between the diamond grains. The metal is linked to the diamond grains in particular in a form and/or material fit. The metal-diamond composite material is in particular manufactured in accordance with an infiltration method, in which the metal is preferably introduced between the diamond grains. The larger the diamond grains are, the smaller the contact surface between the individual grains and also the introduced metal typically is and/or the smaller the proportion by volume of the diamonds. With this form of embodiment the metal-diamond composite material is typically manufactured according to a preferred manufacturing method. This form of embodiment can for example be manufactured, in the manufacturing of the metal-diamond, by composite materials also being inserted into the target element, for example by being covered with the diamond powder.

One form of embodiment makes provision for diamond grains to be dimensioned in such a way that a thermal conductivity of the metal-diamond composite material at room temperature amounts to at least 400 W/(m·K), preferably to at least 600 W/(m·K), especially advantageously to at least 800 W/(m·K), This form of embodiment is in particular advantageous because an effective cooling of the target element via the heat sink can be achieved by it.

One form of embodiment makes provision for the value of the thermal conductivity of the metal-diamond composite material to amount to at least twice, preferably to at least three times, especially advantageously to at least four times the value of the thermal conductivity of the target element. Preferably the thermal conductivity of the metal-diamond composite material thus significantly exceeds that of an in particular conventional target element, which is in particular advantageous because typical target materials such as for example tungsten have a comparatively low thermal conductivity in the range of around 150 W/(m·K).

One form of embodiment makes provision for the diamond grains to be dimensioned in such a way that a coefficient of thermal expansion of the metal-diamond composite material is less than 12 ppm/K, preferably less than 9 ppm/K, especially advantageously less than 6 ppm/K. A coefficient of thermal expansion of tungsten, which is regularly provided as a target material, lies in particular in the range of around 4.3 ppm/K. The smaller the difference between the coefficient of thermal expansion of the metal-diamond composite material and the coefficient of thermal expansion of the target element is, the less is the stress involved in combining these materials.

One form of embodiment makes provision for the value of the coefficient of thermal expansion of the metal-diamond composite material to amount to at most three times, preferably at most twice, especially advantageously at most. 1.5 times the value of the coefficient of thermal expansion of the target element, Preferably the value of the coefficient of thermal expansion of the metal-diamond composite material corresponds to the value of the coefficient of thermal expansion of the target element. One advantage of this form of embodiment is that the heat sink and the target element can advantageously be connected to one another with little stress and thus the thermomechanical stability of the target structure is guaranteed because of the improved cooling. In other words the relative expansion during the heating of the heat sink and of the target element is in a range in which the lifetime connection of the target element to the heat sink is guaranteed.

One form of embodiment makes provision for the target element to be held in the heat sink by material-fit connection, Through this a good thermal connection of the target element to the heat sink is preferably guaranteed. This form of embodiment can for example be manufactured by the target element being introduced as well during the manufacture of metal-diamond composite material, for example held in the diamond powder, or by the target element and the heat sink being in one piece and/or from one casting.

One form of embodiment makes provision for the heat sink to completely surround the target element. In other words the heat sink surrounds the target element in such a way that in particular each side, preferably additionally the side facing towards the vacuum, of the target element is surrounded by the heat sink. On the side facing towards the vacuum, the heat sink preferably has a thickness that is less than 0.3 times, preferably 0.05 times the mean electron free path length in the material of the metal-diamond composite material. Such a heat sink is in particular suitable for a transmission target structure. An advantage of this form of embodiment is that a bending stress and/or a temperature and/or a number of back-scattered electrons is reduced.

In the exemplary embodiments given below the respective electron emitter, the respective housing and the respective target structure can essentially be structured in the same way and/or have essentially the same characteristics, so that an individual adaptation to the respective purpose for which they are used may be generally known and therefore does not have to be repeated separately for each exemplary embodiment.

The electron emitter and the target structure are typically arranged in a housing. The housing is evacuated, preferably with a high vacuum.

The electron emitter is typically arranged on a side of the evacuated housing opposite to the target structure. The electron emitter in particular has a thermionic emitter, for example a spiral emitter or a spherical emitter, or a cold emitter, for example with carbon tubes or silicon tubes. The electron emitter can have a grating to regulate the electron beam.

An x-ray beam emission window, depending on its form of embodiment, can be characterized by it being formed by a cutout in a screening facility, which is arranged around the housing. The cutout can for example be sealed with the target structure or a quasi x-ray beam transparent metal or glass. The x-ray beam emission window, depending on the form of embodiment, in particular encloses the vacuum and thus regularly forms a part of the housing.

An inventive linear electron accelerator has
linearly arranged cavities for acceleration of electrons as part of an evacuated housing,
an electron emitter for emission of the electrons in the housing and
a target structure in the housing,
   wherein the target element is arranged between an x-ray beam emission window of the housing and the electron emitter.

Advantageously in radiotherapy or non-destructive materials or safety testing via the linear electron accelerator a high dose power and a small focal spot can be combined. Typical energy values for example 3 J per pulse with an electron beam diameter of 1.3 mm and an average power of 1 kW.

The linear electron accelerator is in particular embodied for generation of MeV-x-ray radiation. The linear electron accelerator makes it possible to accelerate the electrons in an essentially straight line within the linearly arranged cavities. The linear electron accelerator is in particular multi-energy capable. The cavities are linear accelerator cavities and/or form at least one part of the housing. The housing can furthermore comprise a drift tube connected to the cavities. The linear electron accelerator has the evacuated housing. The target structure is in particular a transmission target structure.

In this form of embodiment the electrons are typically emitted pulsed from the electron emitter into the evacuated housing. The electrons form an electron beam with a current strength of usually up to 1 A.

Depending on the type of the linear electron accelerator the electrons are in particular accelerated via a radio-frequency source into the cavities to energies above 1 MeV. The kinetic energy in the MeV range is typically adjustable and can amount to up to 18 MeV or lie in the range of 3 to 9 MeV.

The radio-frequency source is embodied for acceleration of the electrons within the linearly arranged cavities and typically has a magnetron or a klystron for this purpose. In addition a reflection phase shifter in combination with a circulator for rapid variation of the radio-frequency power can be provided between the radio-frequency source and the cavities.

The linear electron accelerator can for example be used in a stationary or mobile application. A stationary application case is for example used in a medical radiation device. With non-destructive safety testing or materials testing in particular the linear electron accelerator can be arranged on a truck. In principle, any application via the linear electron accelerator can be carried out as a stationary or mobile application.

One form of embodiment makes provision for the target structure to be soldered vacuum-tight to the evacuated housing and to form the x-ray emission window. An advantage of the metal-diamond composite material is that this can in principle be soldered. This makes it possible to use the target structure as an x-ray emission window. Such a target structure is in particular also suitable for use in a stationary anode transmission x-ray tube.

In contrast to the linear electron accelerator, in the x-ray tubes described below no radio-frequency source for acceleration of the electrons is used. For this x-ray tubes typically have a high-voltage source, which accelerates the electrons from a cathode in the direction of the anode. The acceleration voltage amounts for example to between 20 and 150 key. The housing typically features metal and/or glass and/or ceramics.

An inventive stationary anode transmission x-ray tube has
an evacuated housing,
an electron emitter for emission of electrons in the housing and
a target structure as anode in the housing,
   wherein the target element is arranged between an x-ray emission window of the housing and the electron emitter.

The target structure of the stationary anode transmission x-ray tube and of the linear electron accelerator are transmission target structures in each case. The anode employed in these x-ray tubes is a stationary anode and typically has an anode angle of 0°, so that the electron beam strikes the anode surface at right angles.

An inventive stationary anode reflection x-ray tube has
an evacuated housing,
an electron emitter for emission of electrons in the housing and
a target structure as a stationary anode in the housing,
   wherein an x-ray emission window of the housing is arranged to the side of or opposite the target structure.

The stationary anode reflection x-ray tube with the x-ray emission window arranged to the side of the target structure is typically what is known as a side window tube. The stationary anode reflection x-ray tube with the x-ray emission window arranged opposite the target structure is regularly what is known as an end window tube. In the latter case the electron emitter is typically arranged to the side of the target structure, so that the generated x-ray radiation can exit from the housing on the end face side (axially).

The anode used in these x-ray tubes is a stationary anode and can have an anode angle of greater than or equal to 0°, so that the x-ray radiation can exit through the x-ray emission window facing towards the in particular tilted surface.

An inventive rotating anode reflection x-ray tube has
an evacuated housing,
an electron emitter for emission of electrons in the housing and
a target structure as rotating anode in the housing,
   wherein an x-ray emission window of the housing is arranged to the side of or opposite the target structure.

The stationary anode transmission x-ray tube, the stationary anode reflection x-ray tube and the rotating anode reflection x-ray tube feature the heat sink made of the metal-diamond composite material and thus share the advantages previously described for use of the metal-diamond composite material. The stationary anode transmission x-ray tube, the stationary anode reflection x-ray tube and/or the rotating anode reflection x-ray tube are embodied in particular for generation of x-ray radiation up to 1.50 keV.

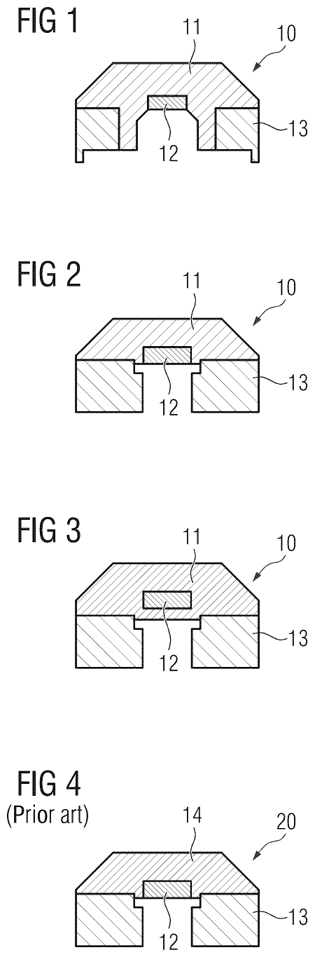

FIG. 1 shows a target structure 10 for generation of x-ray radiation. The target structure 10 has a heat sink 11 and a target element 12 for electrons to strike. The target element 12 is embedded into the heat sink 11 for cooling of the target element 12. The heat sink 11 essentially consists of a metal-diamond composite material.

In this exemplary embodiment the connection of the target structure 10 to an upper section of a housing 13 is shown. The space surrounded by this target structure 10 or by this section of the housing 13 is evacuated during operation and tapers in the direction of the target structure 10. The target element 12 has a lower side exposed to the vacuum. The surface of the upper side of the target element 12 adjoins the heat sink 11 and is thus in contact with it for cooling. The upper side of the heat sink 11 can be embodied with a cooling medium for additional cooling.

FIG. 2 shows the target structure 10 of FIG. 1 in an alternate form of embodiment, which differs in its geometrical design. In this exemplary embodiment the space enclosed by the target structure 10 or the housing 13 has a T shape.

FIG. 3 shows the target structure 10 of FIG. 1 or FIG. 2 in a further form of embodiment, which has a further geometrical design. In this exemplary embodiment the heat sink 11 surrounds the target element 12 completely. The target element 12 is thus separated from the vacuum by a section of the heat sink 11.

The target structures 10 shown in FIGS. 1 to 3, despite their geometrical differences, can in principle be constructed in the same way in each case with individual or in a combination of the individual developments:

In one development the target element 12 consists of silver, copper, gold, aluminum, rhodium, tungsten, molybdenum, rhenium, zirconium, chrome, cobalt, iron, manganese, vanadium, titanium, tantalum, indium, iridium or beryllium or an alloy of the target materials described above, wherein the target element 12 is able to be differentiated structurally from the heat sink 11.

In one development the metal-diamond composite material can have as its metal silver, copper, gold, aluminum, rhodium, tungsten, molybdenum, rhenium, zirconium, chrome, cobalt, iron, manganese, vanadium, titanium, iridium or beryllium.

In an especially advantageous development the metal-diamond composite material is a silver-diamond composite material.

The metal-diamond composite material consists in particular of diamond grains between which metal is located.

The diamond grains are preferably dimensioned in such a way that a thermal conductivity of the metal-diamond composite material at room temperature amounts to at least 400 W/(m·K), preferably to at least 600 W/(m·K), especially advantageous to at least 300 W/(m·K).

The value of the thermal conductivity of the metal-diamond composite materials advantageously amounts to at least twice, preferably to at least three times, especially advantageously to at least four times the value of the thermal conductivity of the target element 12.

The diamond grains can in particular be dimensioned in such a way that a coefficient of thermal expansion of the metal-diamond composite material is less than 12 ppm/K, preferably less than 9 ppm/K, especially advantageously less than 6 ppm/K.

The value of the coefficient of thermal expansion of the metal-diamond composite materials advantageously amounts to at most three times, preferably at most twice, especially advantageously at most 1.5 times the value of the coefficient of thermal expansion of the target element 12.

The target element 12 is preferably held in the heat sink 11 by a material-fit connection.

FIG. 4 shows a conventional target structure 20 in accordance with the prior art for generation of x-ray radiation. The target structure 20 has a conventional heat sink 14 and a target element 12 for electrons to strike. The target element 12 is embedded into the heat sink 14 for cooling of the target element 12. The heat sink 14 features copper in accordance with the prior art.

FIG. 5 shows the thermodynamic behavior of the conventional target structure 20 with copper by way of example.

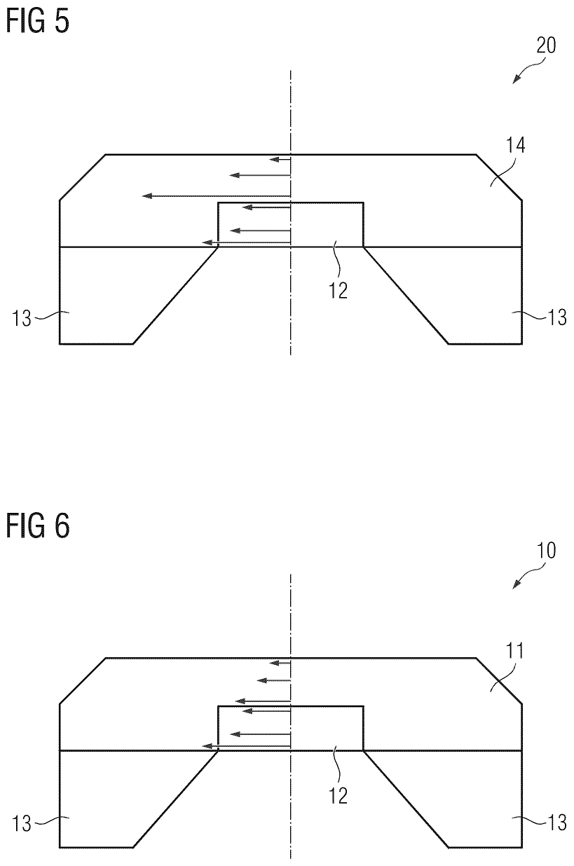

FIG. 6 shows the thermodynamic behavior of the inventive target structure 10 with the metal-diamond composite material by way of example.

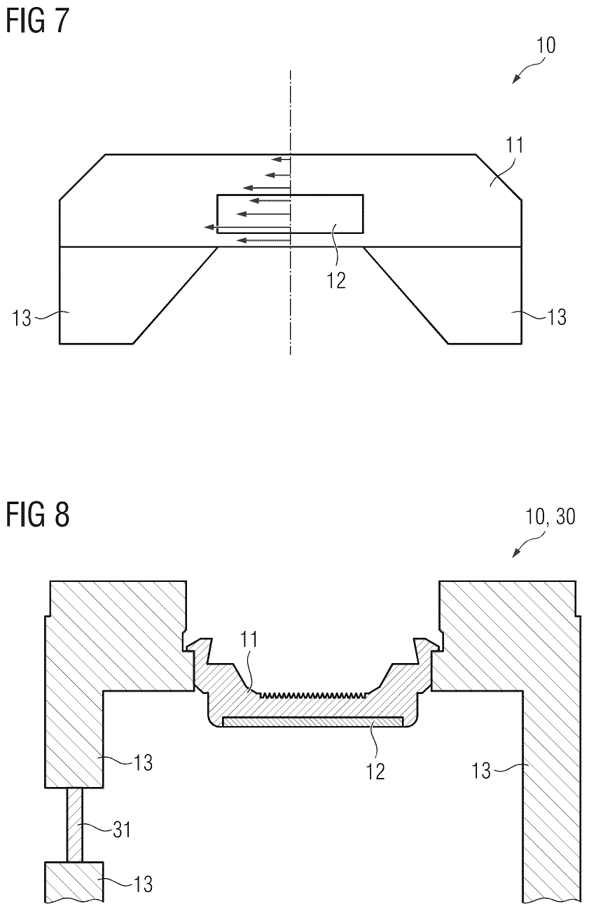

FIG. 7 shows the thermodynamic behavior of the target structure 10 with fully enclosed target element 12 by way of example.

FIGS. 5 to 7 are based on the heat distribution that typically arises in the operation of such target structures 10, 20, The heat distribution comprises in particular temperatures of over 1000° C. in the focal spot of the target element 12, at the boundary surface between target element 12 and heat sink 11 such temperatures in the range of between 200 and 800° C., depending on the size and embodiment of the target, as well as significantly lower temperatures on the sides of the heat sink 11 facing away from the target element 12.

Starting from this intended heat distribution, the arrows identify a sideways-directed, that is to say radial, expansion, which is scaled relatively for the purposes of the illustration.

In the inventive target structure 10 of FIG. 6 it is shown that, by comparison with the conventional target structure 20, at the boundary surface between heat sink 11 and target element 12 there is a significantly lower expansion than between the conventional heat sink 14 and the target element 12.

In the exemplary embodiment of the target structure 10 of FIG. 7 it is shown that, by comparison with the inventive target structure 10 of FIG. 6, the lower side of the target element. 12 facing away from the target element can also actively be cooled in order to reduce the load on the target element 12 during intended operation.

FIG. 8 shows a stationary anode reflection x-ray tube 30 in cross section. The stationary anode reflection x-ray tube 30 has an evacuated housing 13 (only shown in part), an electron emitter (not shown) for emission of electrons in the housing 13 and a target structure 10 as a stationary anode in the housing 13. An x-ray emission window 31 of the housing 13 is arranged to the side of the target structure 10. As an alternative the x-ray emission window can be arranged opposite the target structure 10.

The target structure is suspended in the housing 13 during the manufacturing of the stationary anode reflection x-ray tube 30. The target structure 10 is soldered vacuum-tight to the evacuated housing 13. The rear side of the heat sink 11 is structured in an undulating shape to increase the surface area in order to improve the heat dissipation.

In a development of the stationary anode of the stationary anode reflection x-ray tube 30 to a rotating anode reflection x-ray tube 30 typically essentially the target structure 10 is rotatably supported and optionally embodied in a plate shape.

As an alternative: in a development of the reflection target structure 10 shown to a transmission target structure exemplary embodiment shown in FIG. 8 essentially produces a stationary anode transmission x-ray tube 30, wherein the target structure 10 is preferably arranged between the x-ray emission window 31 of the housing 13 and the electron emitter.

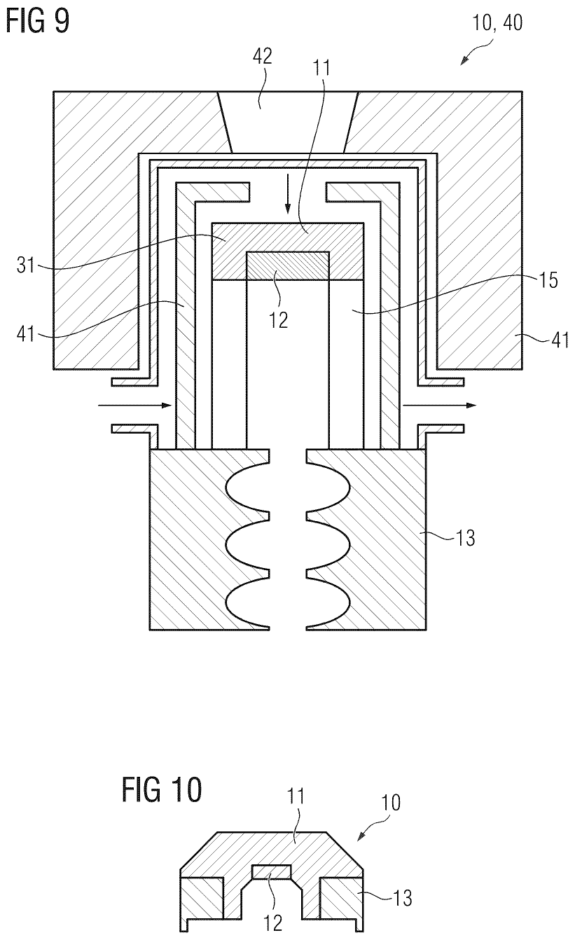

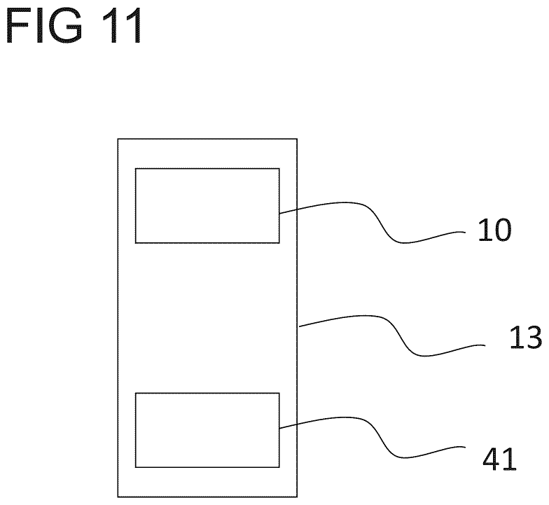

FIG. 9 shows a linear electron accelerator 40. The linear electron accelerator 40 has linearly arranged cavities for acceleration of the electrons as part of an evacuated housing 13, an electron emitter for emission of electrons in the housing 13 (not shown) and a target structure 10 in the housing 13. The target element 12 is arranged between an x-ray emission window 31 of the housing 13 and the electron emitter.

As a development it is conceivable for the target structure 10 to be soldered vacuum-tight to the evacuated housing 13 in order to form the x-ray emission window 31.

Arranged around the housing 13 and shown in sections is a screening facility 41. The screening facility 41 is in particular embodied for reduction of the scattered radiation and in particular features lead for this purpose. In this exemplary embodiment a further x-ray emission window 42 is formed by a cutout in the screening facility 41.

A further part of the housing 13 forms the cylindrical drift tube 15 made of a nickel-iron-cobalt alloy, which connects the target structure 10 with the linearly arranged cavities. The cavities typically consist of copper.

The linear electron accelerator 40, in particular the target structure 10, is able to be cooled with an in particular liquid cooling medium, which is preferably conveyed through the x-ray emission window 31 and along the housing 13 as indicated by the arrows in FIG. 9. The screening facility 41 and/or the housing 13 can in particular be embodied cylindrical in shape in order to make possible the flow of coolant through the tubes embodied thereby. Typically the cooling channels for dissipating heat from the target structure 10 are part of the drift tube 15.

F. 10 shows the target structure 10 of FIG. 1 in the advantageous development when the target element 12 essentially consists of the metal-diamond composite material. In this case the heat sink 11 and the target element 12, thus essentially the target structure 10, thus consist of the same and thus of just one material.

FIG. 11 shows the target structure 10 and the electron emitter 41 within the evacuated housing 13. The schematic arrangement as shown in FIG. 11 applies basically to all electron accelerating units such as the linear electron accelerator 40 or the x-ray tube 30. The electrons are emitted at the electron emitter 41 and are accelerated towards the target structure 10 within an evacuated atmosphere.

It will be understood that, although the terms first second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower.” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented. (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Specific structural and functional details disclosed herein are merely representative for purposes of describing example embodiments. The present invention may, however, be embodied in many alternate forms and should not be construed as limited to only the embodiments set forth herein.

Although the invention has been illustrated and described in greater detail by the preferred exemplary embodiments, despite this the invention is not restricted by the disclosed examples and other variations can be derived herefrom by the person skilled in the art, without departing from the scope of protection of the invention.

1. A target structure for generation of x-ray radiation, comprising:
a heat sink; and
a target element for electrons to strike, the target element being in the heat sink to cool the target element, wherein the heat sink includes a metal-diamond composite material.

2. The target structure of claim 1, wherein the target element includes silver, copper, gold, aluminum, rhodium, tungsten, molybdenum, rhenium, zirconium, chrome, cobalt, iron, manganese, vanadium, titanium, tantalum, indium, iridium or beryllium or an alloy thereof, and the target element is a different structure from the heat sink.

3. The target structure of claim 1, wherein a metal of the metal-diamond composite material is silver, copper, gold, aluminum, rhodium, tungsten, molybdenum, rhenium, zirconium, chrome, cobalt, iron, manganese, vanadium, titanium, iridium or beryllium.

4. The target structure of claim 1, wherein the metal-diamond composite material includes a metal between diamond grains.

5. The target structure of claim 4, wherein a thermal conductivity of the metal-diamond composite material at room temperature is at least 400 W/(m·K).

6. The target structure of claim 5, wherein the thermal conductivity of the metal-diamond composite material is at least twice a thermal conductivity of the target element.

7. The target structure claim 4, wherein a coefficient of thermal expansion of the metal-diamond composite material is less than 12 ppm/K.

8. The target structure of claim 1, wherein a coefficient of thermal expansion of the metal-diamond composite material is at most three times a coefficient of thermal expansion of the target element.

9. The target structure of claim 1, wherein the target element is held in the heat sink by a material-fit connection.

10. The target structure of claim 1, wherein the heat sink completely surrounds the target element.

11. A linear electron accelerator comprising:
linearly arranged cavities configured to accelerate electrons as part of an evacuated housing;
an electron emitter configured to emit the electrons in the evacuated housing; and
the target structure of claim 1 in the evacuated housing, wherein the target element is between an x-ray emission window of the evacuated housing and the electron emitter.

12. The linear electron accelerator of claim 11, wherein the target structure is soldered vacuum-tight to the evacuated housing and forms the x-ray emission window.

13. A stationary anode transmission x-ray tube comprising:
an evacuated housing;
an electron emitter configured to emit electrons in the evacuated housing; and
the target structure of claim 1 being a stationary anode in the evacuated housing, wherein the target element is between an x-ray emission window of the housing and the electron emitter.

14. A stationary anode reflection x-ray tube, comprising:
an evacuated housing;
an electron emitter configured to emit electrons in the evacuated housing; and
the target structure of claim 1 being a stationary anode in the evacuated housing, wherein an x-ray emission window of the evacuated housing is to the side of or opposite the target structure.

15. A rotating anode reflection x-ray tube, comprising:
an evacuated housing;
an electron emitter configured to emit electrons in the housing; and
the target structure of claim 1 being a rotating anode in the evacuated housing, wherein an x-ray emission window of the evacuated housing is to the side of or opposite the target structure.

16. The target structure of claim 2, wherein a metal of the metal-diamond composite material is silver, copper, gold, aluminum, rhodium, tungsten, molybdenum, rhenium, zirconium, chrome, cobalt, iron, manganese, vanadium, titanium, iridium or beryllium.

17. The target structure of claim 16, wherein the metal-diamond composite material includes the metal between diamond grains.

18. The target structure of claim 17, wherein a thermal conductivity of the metal-diamond composite material at room temperature is at least 400 W/(m·K).

19. The target structure of claim 18, wherein the thermal conductivity of the metal-diamond composite material is at least twice a thermal conductivity of the target element.

20. The target structure of claim 17, wherein a coefficient of thermal expansion of the metal-diamond composite material is less than 12 ppm/K.
